(19) United States
(12) Patent Application Publication
(10) Pub. No.: US 2007/0088700 A1
(43) Pub. Date: Apr. 19, 2007

(54) Sending keys that identify changes to clients

(75) Inventors: Pernell James Dykes, Byron, MN (US); William T. Newport, Rochester, MN (US); Jinmei Shen, Rochester, MN (US); Kevin William Sutter, Rochester, MN (US); Hao Wang, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/249,806

(22) Filed: Oct. 13, 2005

(51) Int. Cl. G06F 17/30

(52) U.S. Cl. 707/8

(57) ABSTRACT

A method, apparatus, system, and signal-bearing medium that, in an embodiment, receive a change request from a first client at a first time, where the change request includes a key that identifies a field in a data object. A determination is made that the first client changed the field identified by the key at a second time that is before the first time and that a second client changed the field identified at a third time that is after the second time and before the first time, and the key is sent to the second client. The client receives the key, and in various embodiments invalidates the key in a cache or removes the key from the cache. In an embodiment, the data value of the change request is also sent to the second client, which updates the cache with the data value. In this way, stale data in a cache at a client is either updated or removed.

### FIELD

An embodiment of the invention generally relates to computers. In particular, an embodiment of the invention generally relates to updating or invalidating client local cache data.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

Years ago, computers were stand-alone devices that did not communicate with each other, but today, computers are increasingly connected in networks and one computer, called a client, may request another computer, called a server, to perform an operation. With the advent of the Internet, this client/server model is increasingly being used in online businesses and services, such as online auction houses, stock trading, banking, commerce, and information storage and retrieval.

In order to provide enhanced performance, reliability, and the ability to respond to a variable rate of requests from clients, companies often use multiple servers to respond to requests from clients and replicate their data across the multiple servers. For example, an online clothing online store may have several servers, each of which may include replicated inventory data regarding the clothes that are in stock and available for sale. A common problem with replicated data is keeping the replicated data on different servers synchronized. For example, if a client buys a blue shirt via a request to one server, the inventory data at that server is easily decremented, in order to reflect that the number of blue shirts in stock has decreased by one. But, the inventory data for blue shirts at the other servers is now out-of-date or “stale” and also needs to be decremented, in order to keep the replicated data across all servers synchronized and up-to-date. But, replicating the up-to-date data across servers takes time. In the meantime, if another client also desires to purchase a blue shirt and views the stale inventory data at the other servers, the user may believe that blue shirts are in stock, when in fact they are not. The server might not inform the client that no blue shirts are actually available until the client has already committed to buying the blue shirt, which causes the user at the client disappointment and dissatisfaction. In addition to user dissatisfaction, server resources are wasted for multi-trip server/client checking, failures, retries, and resubmissions.

Currently, only relatively simple stale objects among servers are resolved through replication/synchronization. But, stale objects between clients and servers and are not currently resolved. A stale object can occur at a client when a first client stores data retrieved or updated at a server in a cache local to the first client for the first client's later use, and the data is subsequently updated by a second client without the first client's knowledge. Thus, because many clients can access or update the same data in the same server, a client's local cache is often stale and useless.

Stale objects between clients and servers are a more complicated problem than stale objects between servers because:

(1) the number of clients is potentially much larger than the number of servers;

(2) clients may be spread across a variety of different types of communication links while communications between servers are usually well defined in a simple communication link, e.g. clients might connect to servers via a dial-up connection, DSL (Digital Subscriber Line), cable, a T1 line, a token ring, the Internet, or PPP (Point to Point Protocol); and

(3) clients are often heterogeneous and not under the control of any one company or organization; in contrast, servers are usually homogenous and controlled by a single IT department. For example, a client might be a computer, a cell phone, or a PDA (Personal Digital Assistant).

Further, while servers can use locking and synchronization techniques to address stale data, these server replication technologies cannot be used between clients and servers to resolve the client's local stale cache problems.

Thus, a better technique is needed to handle stale data in a client's local cache.

### SUMMARY

A method, apparatus, system, and signal-bearing medium are provided that, in an embodiment, receive a change request from a first client at a first time, where the change request includes a key that identifies a field in a data object. A determination is made that the first client changed the field identified by the key at a second time that is before the first time and that a second client changed the field identified at a third time that is after the second time and before the first time, and the key is sent to the second client. The client receives the key, and in various embodiments invalidates the key in a cache or removes the key from the cache. In an embodiment, the data value of the change request is also sent to the second client, which updates the cache with the data value. In this way, stale data in a cache at a client is either updated or removed.

### BRIEF DESCRIPTION OF THE DRAWING

Various embodiments of the present invention are hereinafter described in conjunction with the appended drawings:

FIG. 1 depicts a block diagram of an example system for implementing an embodiment of the invention.

FIG. 2 depicts a block diagram of an example data structure for client history data, according to an embodiment of the invention.

FIG. 3 depicts a block diagram of an example data structure for server history change data, according to an embodiment of the invention.

FIG. 4 depicts a flowchart of example processing for a request from a client, according to an embodiment of the invention.

FIG. 5 depicts a flowchart of example processing for handling a cache at a client, according to an embodiment of the invention.

FIG. 6 depicts a flowchart of example processing for erasing the oldest records in the client history data and server history change data, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

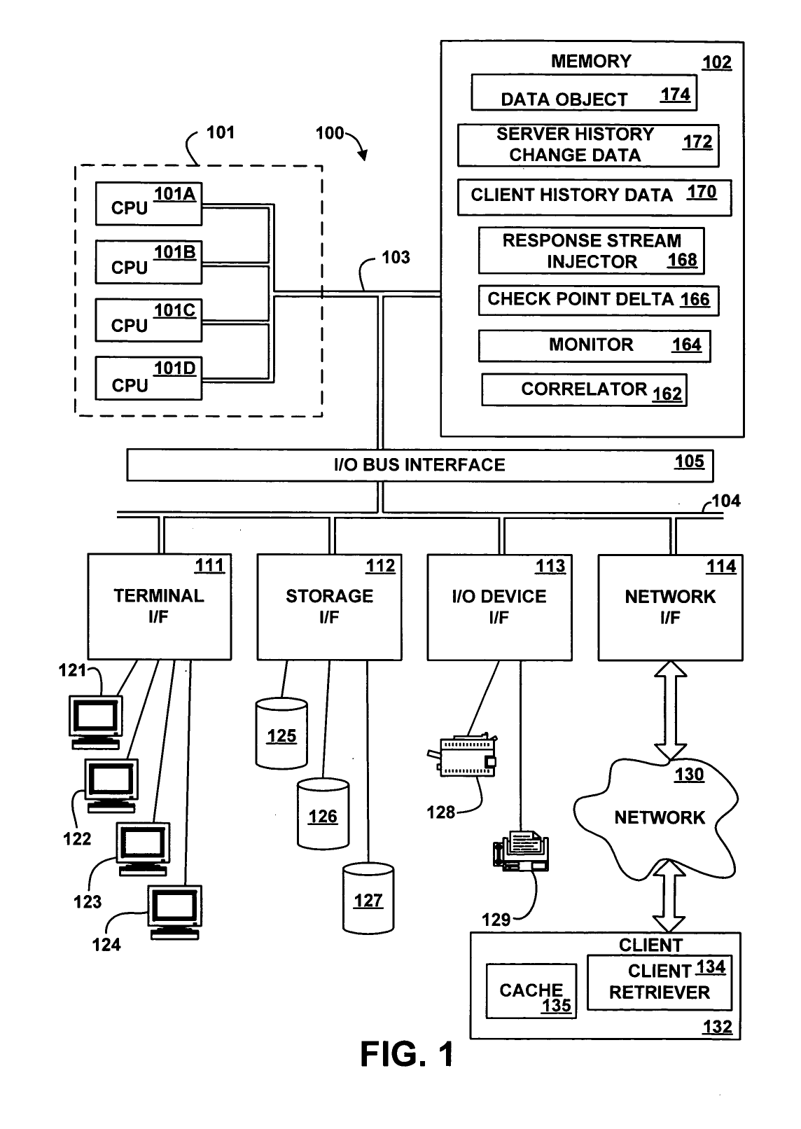

Referring to the Drawings, wherein like numbers denote like parts throughout the several views, FIG. 1 depicts a high-level block diagram representation of a server computer system 100 connected via a network 130 to a client 132, according to an embodiment of the present invention. The terms “computer system,” “server,” and “client,” are used for convenience only, any appropriate electronic devices may be used, in various embodiments the computer system 100 may operate as either a client or a server, and a computer system or electronic device that operates as a client in one context may operate as a server in another context. The major components of the server computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The server computer system 100 contains one or more general-purpose programmable central processing units (CPUs) 101A, 101B, 101C, and 101D, herein generically referred to as a processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The main memory 102 includes a correlator 162, a monitor 164, a check point delta 166, a response stream injector 168, client history data 170, server history change data 172, and a data object 174. Although the correlator 162, the monitor 164, the check point delta 166, the response stream injector 168, the client history data 170, the server history change data 172, and the data object 174 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the correlator 162, the monitor 164, the check point delta 166, the response stream injector 168, the client history data 170, the server history change data 172, and the data object 174 are illustrated as being contained within the main memory 102, these elements are not necessarily all completely contained in the same physical storage device at the same time. Further, although the correlator 162, the monitor 164, the check point delta 166, the response stream injector 168, the client history data 170, the server history change data 172, and the data object 174 are illustrated as being separate entities, in other embodiments some of them, or portions of some of them, may be packaged together.

The correlator 162 finds, via the server history change data 172, multiple clients that have accessed data in the data object 174 via the same key. The monitor 164 monitors changes to the data object 174 and records information regarding the changes in the client history data 170 and the server history change data 172. The check point delta 166 retrieves information from the server history change data 172. The response stream injector 168 builds responses that are sent to the clients 132. The client history data 170 includes information about the clients 132 and the keys that the clients 132 have used to access the data object 174, including both retrievals and changes. The server history change data 172 includes a history of changes made to the data object 174.

The data object 174 may be a database, a table, a file, any other appropriate type of data repository that may be accessed via keys, or any portion thereof. A relational database stores data in tables. A table is a set of rows and columns. Each row is a set of columns with a value for each column. The rows are analogous to records, and the columns are analogous to fields. A key consists of one or more columns (fields), and the value of a key identifies a row (record) in a table.

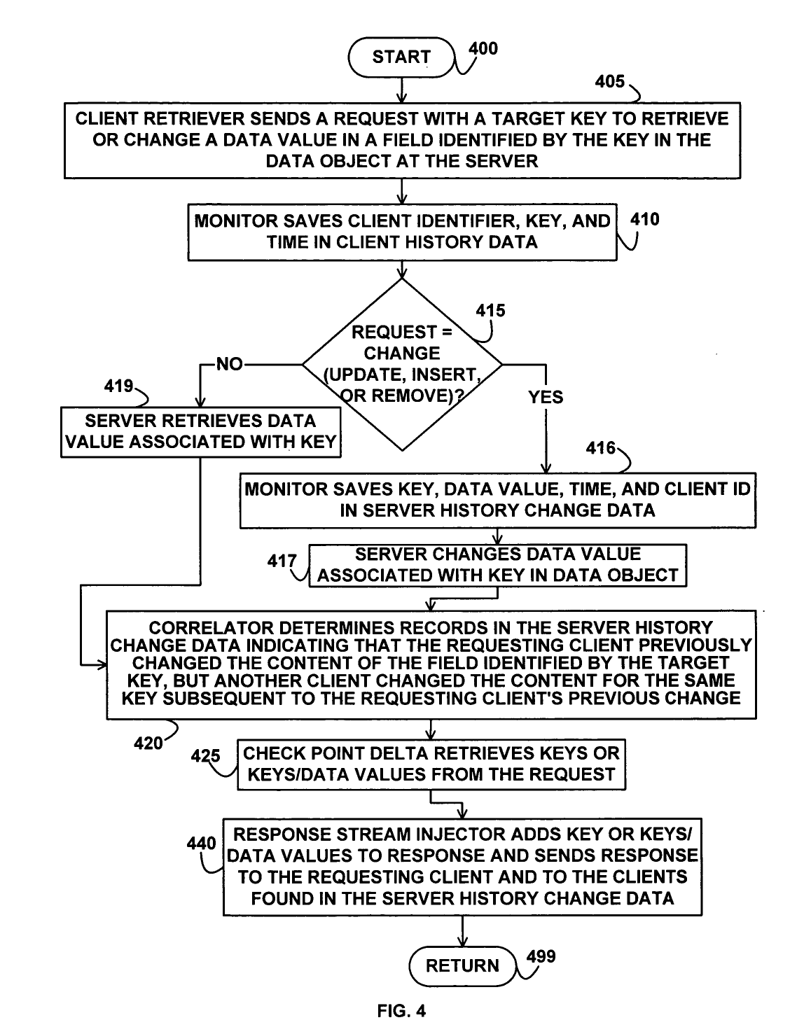

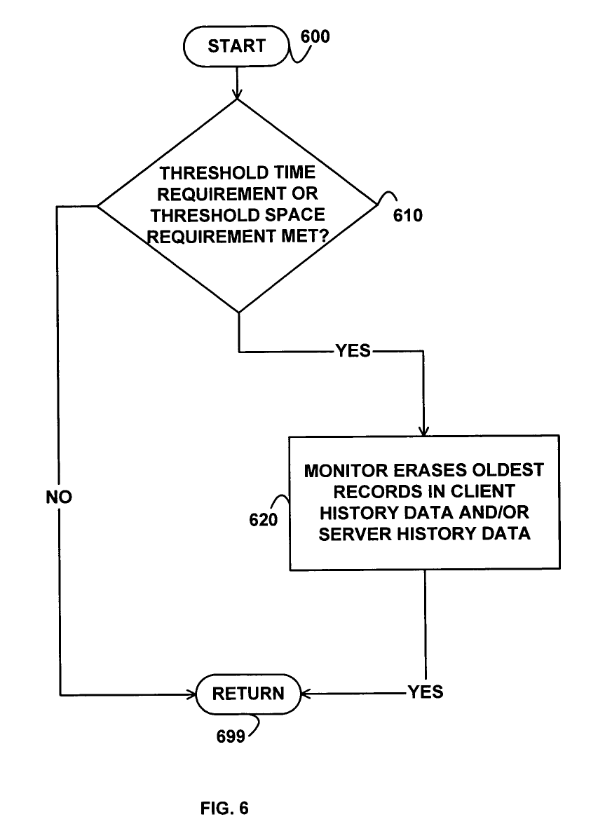

In an embodiment, some or all of the correlator 162, the monitor 164, the check point delta 166, and/or the response stream injector 168 include instructions stored in the memory 102 capable of executing on the processor 101 or statements capable of being interpreted by instructions executing on the processor 101 to perform the functions as further described below with reference to FIGS. 4 and 6. In another embodiment, some or all of the correlator 162, the monitor 164, the check point delta 166 may be implemented in microcode or firmware. In another embodiment, some or all of the correlator 162, the monitor 164, the check point delta 166 may be implemented in hardware via logic gates and/or other appropriate hardware techniques.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127.

The I/O device interface 113 provides an interface to any of various other input/output devices or devices of other types. Two such devices, the printer 128 and the fax machine 129, are shown in the exemplary embodiment of FIG. 1, but in other embodiments many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3×specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

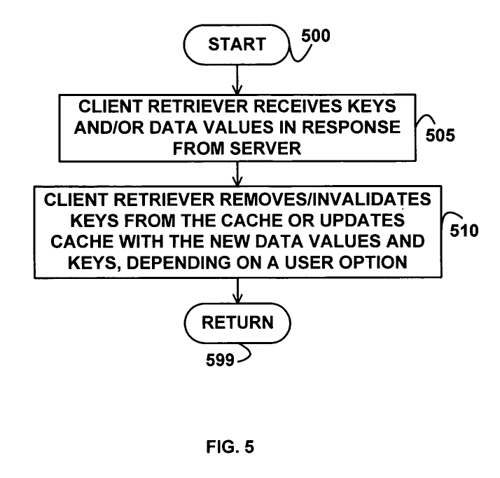

The clients 132 may include any or all of the components previously described above for the server computer system 100. The clients 132 include a client retriever 134 and a cache 135. The client retriever 134 sends requests with target keys to the server computer system 100 to retrieve data from the data object 174 and/or to update data in the data object 174 and stores the data and/or keys in the cache 135. A client retriever 134 at one client 132 may receive a response to a request initiated by another client 132 if multiple clients 132 request changes to the same data object 174 via the same key, as further described below with reference to FIGS. 4 and 5.

In an embodiment, the client retriever 134 includes instructions capable of executing on a processor (analogous to the processor 101) or statements capable of being interpreted by instructions executing on a processor to perform the functions as further described below with reference to FIGS. 4 and 5. In another embodiment, the client retriever 134 may be implemented in microcode or firmware. In another embodiment, the client retriever 134 may be implemented in hardware via logic gates and/or other appropriate hardware techniques.

It should be understood that FIG. 1 is intended to depict the representative major components of the computer system 100, the network 130, and the client 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions or statements that are resident at various times in various memory and storage devices in the computer system 100 and/or the client 132, and that, when read and executed by one or more processors in the computer system 100 and/or the client 132, cause the computer system 100 and/or the client 132 to perform the steps necessary to execute steps or elements comprising the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 and/or the client 132 via a variety of tangible computer recordable and readable signal-bearing media, which include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications medium, such as through a computer or a telephone network, e.g., the network 130.

Such tangible signal-bearing media, when carrying machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

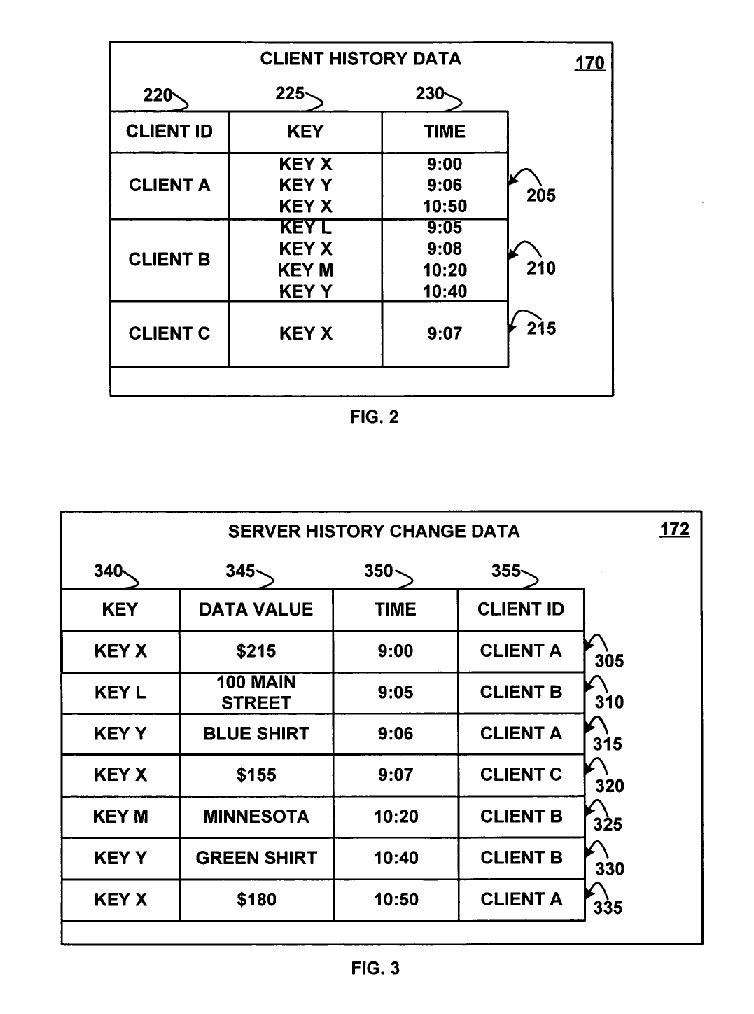

FIG. 2 depicts a block diagram of an example data structure for the client history data 170, according to an embodiment of the invention. The client history data 170 includes records 205, 210, and 215, but in other embodiments any number of records with any appropriate data may be present. In an embodiment, when the client history data 170 is too large, the oldest data records are erased to fit a threshold time requirement or a threshold space requirement. For example, in an embodiment, the threshold time requirement may be to keep one day's worth of the client history data 170, or the threshold space requirement may be to keep 100 MB per client 132, but in other embodiments any appropriate threshold time requirement and/or threshold space requirement may be used. The threshold time and space requirements are further described below with reference to FIG. 6.

Each of the records 205, 210, and 215 includes a client identifier field 220, a key field 225, and a time field 230, but in other embodiments, more or fewer fields may be present. The client identifier field 220 identifies a client 132 that changed or accessed data in the data object 174 associated with the key 225. The key field 225 identifies a key(s) in the data object 174. The time field 230 identifies a time(s) and/or date(s) that data in the data object 174 associated with the key 225 was last changed or accessed.

FIG. 3 depicts a block diagram of an example data structure for the server history change data 172, according to an embodiment of the invention. Each server 100 has one copy of the server history change data 172. The server 100 records data changes (update/insert/delete) to the data object 174 requested by the clients 132 in the server history change data 172 that make client cache 135 stale. The server history change data 172 does not include data regarding mere retrievals of data from the data object 174 because they do not change the data in the data object 174, and thus do not make the client local data in the cache 135 stale. When the server history change data 172 becomes too large, the oldest records are erased, according to the threshold time or space requirements, as further described below with reference to FIG. 6.

The server history change data 172 includes records 305, 310, 315, 320, 325, 330, and 335, but in other embodiments any number of records with any appropriate data may be present. Each of the records 305, 310, 315, 320, 325, 330, and 335 includes a key field 340, a data value field 345, a time field 350, and a client identifier field 355, but in other embodiments, more or fewer fields may be present. The key field 340 identifies a key in the data object 174. The data value field 345 includes the most recent value (at the time 350) of data in the data object 174 that is associated with the key 340. The time field 350 includes the time and/or data that the data value 345 was most recently changed. The client identifier field 355 identifies a client 132 that requested the change.

FIG. 4 depicts a flowchart of example processing, according to an embodiment of the invention. Control begins at block 400. Control then continues to block 405 where the client retriever 134 at a requesting client 132 sends a request with a target key and optionally a target data value to the server 100 to retrieve, insert, delete, or update the content of a field, record, or row identified by the target key in the data object 174. Control then continues to block 410 where the monitor 164 creates a new record in the client history data 170 with the client identifier 220 of the requesting client or finds an existing record for the requesting client based on the client identifier field 220 in the client history data 170. The monitor 164 then saves the received target key in the field 225 of the record, and saves the time of receipt of the request in the field 230 of the record. For example, if the requesting client identifier is “client A,” with an associated target key of “key X” and the receiving time of the request is “10:50,” then the monitor 164 saves the target key “key X” in the key field 225 and “10:50” in the time field 230 of the record 205 in the client history data 170 of FIG. 2.

Control then continues to block 415 where the correlator 162 determines whether the received request is a request that will change a data value in the data object 174 at the server 100, such as an update, delete, or insert request.

If the determination at block 415 is true, then the received request is a change request, so control continues to block 416 where the monitor 164 saves a history of the change by creating a new record in the server history change data 172 and saving the target key associated with the request, the new target data value associated with the target key of the request, the time of the request, and an identifier of the client 132 that initiated the request in the key 340, the data value 345, the time 350, and the client identifier 355, respectively, in the newly-created record. Using the same example as above for block 410, if the request is an update request with a target data value of “$180,” then the monitor 164 creates the record 335 in the server history change data 172 and saves the target “key X” in the key field 340, the target data value “$180” in the data value field 345, the time “10:50” of the change in the time field 350, and the requesting client “client A” in the client identifier field 355.

Control then continues to block 417 where the server 100 changes (updates, deletes, or inserts) the data object 174 with the new target data value associated with the target key. If the change fails, the server 100 rolls back the data in the data object 174 based on the server history change data 172.

Control then continues to block 420 where the correlator 162 finds records in the server history change data 172 indicating that the requesting client previously changed (requested a change to) the content of the field (in the data object 174) associated with the requested target key, but another client changed (requested a change to) the content of the field for the same key after the requesting client's previous change. Thus, the correlator 162 finds a record in the server history change data 172 with a key 340 that matches the key 225 (the target key in the record created at block 410 associated with the current request) and a client identifier 355 that matches the requesting client. The time 350 associated with the requesting client's previous change is before the time 230 associated with the requesting client's current change. Then, the correlator 162 searches the server history change data 172 for other records with a key 340 that matches the target key and a time 350 after the time of the requesting client's previous change.

Using the example of FIGS. 2 and 3, if the current request from the requesting client 132 is reflected in record 205 as the client 220 of “client A” accessing the key 225 of the target key “key X” at a time 230 of “10:50,” then the correlator 162 searches the server history change data 172 and finds the record 305, indicating that the same client 355 “client A” changed data content in the field associated with the same key 340 “key X” as the target key at a previous time 350 “9:00” (previous to “10:50” in record 335). Then, the correlator 162 searches the server history change data 172 and finds the record 320, indicating that the data content in the field associated with the same key 340 (“key X”) as the target key was changed by another client 355 (“client C”) at time 350 (“9:07”) that is after the requesting client's previous change time 350 (“9:00” in record 305) and before the requesting client's current change time 350 (“10:50” in record 335).

Control then continues to block 425 where the client-server check point delta 166 retrieves the key 340, which is the target key, or the keys 340 and the data values 345 from the records found at block 420 or from the request. The data values 345 may include the target data value of the current request (e.g., the data value 345 in the record 335), the data value associated with the previous change from the requesting client, (e.g., the data value 345 in the record 305), or the data value associated with the other client that was changed after the requesting client's previous change (e.g., the data value 345 in the record 320).

Control then continues to block 440 where the response stream injector 168 adds the retrieved keys 340 or keys 340/data values 345 to the response stream and sends the response stream to the requesting client and to the other clients 355 identified in the records in the server history change data 172 that were found at block 420 (e.g., the “client C” from record 320). Control then continues to block 499 where the logic of FIG. 4 returns.

If the determination at block 415 is false, then the request is a retrieval request, so control continues to block 419 where the server 100 retrieves the data associated with the target key of the request from the data object 174. Control then continues to block 420, as previously described above.

FIG. 5 depicts a flowchart of example processing for handling a client local cache 135, according to an embodiment of the invention. Control begins at block 500. Control then continues to block 505 where the client retriever 134 at the client 132 receives keys and/or data values in response from the server 100. The response may be a response to a request that the client initiated or a response to a request initiated by another client if multiple clients requested changes via the same key in the same data object 174, in which case multiple clients receive and process the response. When a client receives a key in response to a request from another client, the client is receiving the key because the client's cache may include data that is stale (out-of date) due to a change to the data that was requested by another client. Control then continues to block 510 where the client retriever 134 removes/invalidates the received keys from the cache 135 local to the client or updates the cache 135 with the new data values and/or keys, depending on a user option. Control then continues to block 599 where the logic of FIG. 5 returns.

FIG. 6 depicts a flowchart of example processing for erasing the oldest records in the client history data 170 and the server history change data 172, according to an embodiment of the invention. The logic of FIG. 6 is executed periodically or when the server memory 102 reaches a maximum condition. Control begins at block 600. Control then continues to block 610 where the monitor 164 determines whether the threshold time requirement or the threshold space requirement is reached for the client history data 170 or the server history change data 172. If the determination at block 610 is true, then the threshold time requirement or the threshold space requirement is reached for the client history data 170 or the server history change data 172, so control continues to block 620 where the monitor 164 erases the oldest records in the client history data 170 or the server history change data 172, as appropriate. Control then continues to block 699 where the logic of FIG. 6 returns. If the determination at block 610 is false, then the threshold time requirement or the threshold space requirement is not reached for the client history data 170 or the server history change data 172, so control continues to block 699 where the logic of FIG. 6 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
receiving a change request from a first client at a first time, wherein the change request comprises a key that identifies a field in a data object;
determining that the first client changed content of the field identified by the key at a second time, wherein the second time is before the first time;
deciding that a second client changed the content of the field identified by the key at a third time, wherein the third time is after the second time and before the first time; and
sending the key to the second client.

2. The method of claim 1, wherein the second client receives the key and invalidates the key in a cache.

3. The method of claim 1, wherein the second client receives the key and removes the key from a cache.

4. The method of claim 1, wherein the sending further comprises:
sending a data value to the second client, wherein the change request further comprises the data value, and wherein the data value is associated with the key.

5. The method of claim 4, wherein the second client updates a cache with the data value.

6. The method of claim 4, further comprising:
changing the data object with the data value via the key.

7. The method of claim 1, further comprising:
saving a history of a plurality of change requests from a plurality of clients, wherein the determining and the deciding access the history.

8. A signal-bearing medium encoded with instructions, wherein the instructions when executed comprise:
receiving a change request from a first client at a first time, wherein the change request comprises a key that identifies a field in a data object;
determining that the first client changed content of the field identified by the key at a second time, wherein the second time is before the first time;
deciding that a second client changed the content of the field identified by the key at a third time, wherein the third time is after the second time and before the first time;
changing the data object via the key; and
sending the key to the second client.

9. The signal-bearing medium of claim 8, wherein the second client receives the key and invalidates the key in a cache.

10. The signal-bearing medium of claim 8, wherein the second client receives the key and removes the key from a cache.

11. The signal-bearing medium of claim 8, wherein the sending further comprises:
sending a data value to the second client, wherein the change request further comprises the data value, and wherein the data value is associated with the key.

12. The signal-bearing medium of claim 11, wherein the second client updates a cache with the data value.

13. The signal-bearing medium of claim 8, further comprising:
saving a history of a plurality of change requests from a plurality of clients, wherein the determining and the deciding access the history.

14. The signal-bearing medium of claim 13, further comprising:
periodically erasing oldest records from the history.

15. A computer system comprising a processor communicatively connected to the signal-bearing medium of claim 8.

16. A method for configuring a computer, comprising:
configuring the computer to receive a change request from a first client at a first time, wherein the change request comprises a key that identifies a field in a data object;
configuring the computer to determine that the first client changed content of the field identified by the key at a second time, wherein the second time is before the first time;
configuring the computer to decide that a second client changed the content of the field identified by the key at a third time, wherein the third time is after the second time and before the first time;
configuring the computer to change the data object via the key;
configuring the computer to send the key to the first client and to the second client;
configuring the computer to save a history of a plurality of change requests from a plurality of clients, wherein the determining and the deciding access the history; and
configuring the computer to periodically erase oldest records from the history.

17. The method of claim 16, wherein the second client receives the key and invalidates the key in a cache.

18. The method of claim 16, wherein the second client receives the key and removes the key from a cache.

19. The method of claim 16, wherein the configuring the computer to send further comprises:
configuring the computer to send a data value to the second client, wherein the change request further comprises the data value, and wherein the data value is associated with the key.

20. The method of claim 19, wherein the first client updates a first cache with the data value and wherein the second client updates the second cache with the data value.
